(19) United States
(12) Patent Application Publication
(10) Pub. No.: US 2004/0033302 A1
(43) Pub. Date: Feb. 19, 2004

(54) Bland-tasting edible product

(76) Inventors: Himanshu Shah, Branchburg, NJ (US); Ai Tsing Tan, Singapore (SG)

Correspondence Address: Karen G. Kaiser, NATIONAL STARCH AND CHEMICAL COMPANY, 10 Finderne Avenue, Bridgewater, NJ, 08807-0500, US

(21) Appl. No.: 10/638,916

(22) Filed: Aug. 11, 2003

Related U.S. Application Data
(60) Provisional application No. 60/403,284, filed on Aug. 14, 2002.

(51) Int. Cl. A23L 1/05

(52) U.S. Cl. 426/578

(57) ABSTRACT

This patent pertains to the use of a noninhibited, stabilized starch in edible products, including powdered shortenings and non-dairy creamers, containing alkenyl succinated starches. The addition of such starches improves the overall flavor of such products, reducing or even eliminating the bitter notes commonly associated with the presence of alkenyl succinated starches in such products.

### BACKGROUND OF THE INVENTION

The present invention relates to a bland tasting edible product such as a powdered shortening or non-dairy creamer comprising a fat component emulsified or encapsulated with an alkenyl succinated starch, and a noninhibited, stabilized starch.

Stable emulsions of finely divided fat have been used in the art for many purposes, including for use in powdered shortenings and in coffee whiteners. One method typically used for emulsifying such fat is through the use of alkenyl succinated starches.

Unfortunately, the use of these emulsions has presented difficult problems to the art. In particular, non-dairy creamers which use alkenyl succinated starches to emulsify or encapsulate the fat component tend to have undesirable bitter notes.

Surprisingly, it has now been discovered that the addition of a noninhibited, stabilized starch to edible products such creamer formulations eliminates the bitter notes associated with the use of alkenyl succinated starches, improving the overall flavor of the edible products.

### SUMMARY OF THE INVENTION

This patent pertains to the use of a noninhibited, stabilized starch in an edible product such as a powdered shortening or non-dairy creamer containing alkenyl succinated starches. The addition of such starches improves the flavor of the product, reducing or eliminating any undesirable bitter notes commonly associated with the presence of alkenyl succinated starches in such products.

As used herein, the term non-inhibited is intended to mean a starch which has not been modified by crosslinking or by thermal inhibition such as described in U.S. Pat. No. 5,725,676.

As used herein, the term alkenyl succinated starches is intended to mean starches which have been modified using succinic anhydrides to yield starch esters, including without limitation octenyl succinic anhydride (OSA) and dodecenyl succinic anhydride (DDSA). Such alkenyl succinated starches and their methods of preparation are well known in the art and some are commercially available.

### DETAILED DESCRIPTION OF THE INVENTION

This patent pertains to the use of a stabilized starch in an edible product such as a powdered shortening or non-dairy creamer containing alkenyl succinated starches. The addition of such starches improves the overall flavor of the product, specifically reducing or eliminating any bitter notes commonly associated with the presence of alkenyl succinated starches in such products.

Starch, as used herein, is intended to include all starches derived from any native source, any of which may be suitable for use herein. A native starch as used herein, is one as it is found in nature. Also suitable are starches derived from a plant obtained by standard breeding techniques including crossbreeding, translocation, inversion, transformation or any other method of gene or chromosome engineering to include variations thereof. In addition, starch derived from a plant grown from artificial mutations and variations of the above generic composition, which may be produced by known standard methods of mutation breeding, are also suitable herein.

Typical sources for the starches are cereals, tubers, roots, legumes and fruits. The native source can be any variety of corn (maize), pea, potato, sweet potato, banana, barley, wheat, rice, oat, sago, amaranth, tapioca (cassava), arrowroot, canna, sorghum, and waxy and high amylose varieties thereof. As used herein, the term waxy is intended to mean a starch which contains less amylose than the typical variety thereof, particularly less than about 5%, more particularly less than about 3%, and most particularly less than about 1% amylose by weight. As used herein, the term high amylose is intended to mean a starch which contains more amylose than the typical variety thereof, particularly at least about 40%, more particularly at least about 70%, more particularly at least about 80% amylose by weight. Particularly suitable starches include tapioca, rice, corn and waxy varieties thereof.

The starch is then stabilized using methods known in the art, for example in Modified Starches: Properties and Uses, Ed. Wurzburg, CRC Press, Inc., Florida (1986). Stabilized starches is intended to mean starches which have been modified to substantially reduce or eliminate retrogradation and includes without limitation chemically modified starches which have been hydroxyalkylated, acetylated, or mono-phosphorylated. Suitable stabilizing agents suitable for hydroxyalkylation are alkylene oxides, such as ethylene, propylene, and butylene oxide, particularly propylene oxide. Hydroxyalkylation may be at any level effective to stabilize the starch and is typically added in an amount of about 1% to about 25%, particularly from about 3 to about 20%, most particularly from about 5 to about 15%, by weight of the starch. Acetylation, using for example acetic anhydride, may be at any level effective to stabilize the starch and is typically added in an amount of 1% to about 10%, particularly from about 2.5 to about 7.5%, most particularly from about 3.5 to about 6.0%, by weight of the starch. Mono-phosphorylated starch, using for example orthophosphates, sodium tripolyphosphate, urea-phosphates or organic phosphorylating reagents, particularly sodium tri polyphosphate or sodium trimetaphosphate, may be at any level effective to stabilize the starch and is typically added in an amount of 0.01% to about 0.6% phosphorus, particularly from about 0.05 to about 0.4% phosphorus, most particularly from about 0.2 to about 0.4% phosporous, by weight of the starch. The starch may also be stabilized by oxidation such as chlorination, particularly if the starch is a waxy starch, or by acid or enzyme hydrolysis. Particularly useful stabilization is by chemical modification.

The base starch or stabilized starch for use herein may be purified by any method known in the art to remove starch off flavors and colors that are native to the polysaccharide or created during processing. Suitable purification processes for treating starches are disclosed in the family of patents represented by EP 554 818 (Kasica, et al.). Alkali washing techniques are also useful and described in the family of patents represented by U.S. Pat. No. 4,477,480 (Seidel) and U.S. Pat. No. 5,187,272 (Bertalan et al.).

The resultant starch is typically adjusted to the desired pH according to its intended end use. In general, the pH is adjusted to from about 5.0 to about 7.5, particularly from about 6.0 to about 7.0, using techniques known in the art.

The stabilized starch composition is used in combination with an alkenyl succinated starch with which a fat has been emulsified or encapsulated, in order to improve the flavor of the edible product, particularly to reduce or eliminate the bitter notes typically associated with such alkenyl succinated starch/fat products.

Alkenyl succinated starches are well known in the art for use as emulsifying and encapsulating agents and any such starch is suitable for use herein. The alkenyl succinated starch may be prepared from any of the base starches described above for preparation of the stabilized starch, particularly waxy starches, more particularly waxy maize starches. The starch base for the alkenyl succinated starch may be the same as or different from the starch base for the stabilized starch. The alkenyl succinated starch is typically hydrolyzed or dextrinized to reduce the molecular weight.

As used herein, the term fat is interchangeable with oil. The fat used is not critical and may be any of the fats normally used in dry powdered fat emulsions, including vegetable fats and animal fats such as lard and tallow, particularly vegetable fats. Any vegetable fat may be used, including those fats taken from palm seeds, olives, rape seeds, cocoa butter, sesame seeds, sorghum, babassu, and the like, but the more bland vegetable fats are more typically used, such as palm seed oil, coconut oil, soy bean oil, cotton seed oil, peanut oil, sunflower oil, corn oil, rapeseed oil, and safflower seed oil. The fat may be a single fat or a mixture of two or more fats. The fats may be in the native state, or may be partially or fully hydrogenated. The fats may be liquids or solids at room temperature.

The amount of fat may vary according to the edible product intended and is typically present in an amount of from about 10 to about 90% by weight of the product. When the end product is a non-dairy creamer, the fat content is generally from about 10 to about 50%, particularly from about 30 to about 40%.

The fat is typically in a very finely divided form, particularly having an average particle size of no more than about 4 microns, to obtain the required emulsification for high stability. In a particularly suitable embodiment, the average particle size of the fat is less than about 3 microns, more particularly less than about 1.5 microns, most particularly from about 0.4 to about 1.5 microns.

The fat emulsion/encapuslation may be either a dry powdered or a liquid form, and the liquid form may be either an undried form of the emulsion or may be a reconstitution in water of the dried emulsion/encapsulation.

The fat is emulsified or encapsulated by the alkenyl succinated starch using methods known in the art, particularly by homogenization or other high shear processes.

The stabilized starch may be mixed with the alkenyl succinated starch prior to emulsification/encapsulation, during the emulsification/encapsulation process, or may be mixed with the emulsified/encapsulated fat product. In the alternative, the alkenyl succinated starch may be stabilized.

The stabilized starch may be used in any amount desired or necessary to obtain functionality (improve flavor by bitter note reduction/elimination) in the edible product. In general, the stabilized starch may be added in an amount of at least about 0.05% particularly at least about 0.4% by weight of the edible product and in an amount of no more than about 1.5%, particularly no more than about 0.8% by weight of the edible product.

Additives may be added to the edible product, particularly filler. The filler functions to form a matrix which will keep the fat particles, in the dried composition, dispersed and separated form each other so as to avoid agglomeration in storage, transportation and the like. Although not necessary, the filler may give a sweetening effect to the emulsion, especially when corn syrup solids and other sugars are used as the filler. Also useful as fillers are carbohydrates, particularly those which are water soluble such as hydrolyzed starches including dextrins and maltodextrins, and vegetable gums.

Other optional additives may be present depending upon the edible product used. Such optional additives includes without limitation flavors, colors, emulsifiers, stabilizers such as gums, preservatives, antioxidants, anti-caking agents, salts, acids and acidic stabilizing salts.

The stabilized starch may be used in a variety of edible products containing an alkenyl succinic starch including, but not limited to: shortenings, coffee whiteners and creamers (including protein-free and/or non-dairy such as the ones disclosed in U.S. Pat. No. 4,460,617, hereby incorporated by reference, and sodium caseinate creamers); creamers for fruit drinks, soft drinks (liquid or powder), soups, brewed tea (hot or cold), gelatin desserts; bases for sherbert-like frozen desserts; fat for vinegar containing salad dressings; gravies; and non-dairy bar mixes. The stabilized starch is particularly useful in shortenings, coffee whiteners and creamers.

### EXAMPLES

The following examples are presented to further illustrate and explain the present invention and should not be taken as limiting in any regard. All percents used are on a weight/weight basis. The following test procedures are used throughout the examples:

### Example 1

### Preparation of Non-Dairy Creamer Based on Sodium Starch Octenyl Succinate with Stabilized Starch

| A. Ingredients | Amount (% wt/wt) |
|---|---|
| Palm Oil | 21 |
| 3% OSA treated fluidity (20-40 WF) | 2.7 |
| corn waxy starch | |
| 8% propylene oxide treated fluidity | 0.3 |
| (9-19 WF) tapioca starch | |
| Corn Syrup Solid (42DE) | 36 |
| Water | 40 |
| Total | 100 |

Procedure:

1. The solid fat was liquefied by heating in a boiling water bath and the fat temperature was maintained at 140-150° F. (˜60-65° C.) once liquefied.

2. Water was heated to 140-150° F. (˜60-65° C.) and starch was added under moderate agitation until completely dispersed.

3. To the above starch solution, corn syrup solids were added under moderate agitation until the ingredients were thoroughly mixed.

4. While maintaining the starch/corn syrup solids solution at 140-150° F. (˜60-65° C.), the oil was added to the solution using Arde Barinco Benchtop Homogenizer while mixing at 30 setting for two minutes.

5. The above pre-emulsion was homogenized in two passes at 3000/500 psi (20,684,271/3,447,378.5 Pa).

6. The particle size of the emulsion was checked. Mean particle size should be less than 1.5 microns. If necessary to obtain the desired particle size distribution, the emulsion was homogenized one more pass.

7. The emulsion was spray dried using an outlet temperature between 110-120° C. Throughout the process, the temperature of emulsion was maintained at around 140-150° F. (˜60-65° C.).

8. The creamer was dry blended with 1% w/w phosphate salt.

B. The above example was repeated with the exception that a 5% acetylated fluidity (9-19 wf) tapioca starch was used in place of the propylene oxide treated starch of Example 1A.

C. The above example was, repeated with the exception that a chlorinated (5.5% chlorine as sodium hypochlorite) fluidity (9-19 wf) tapioca starch was used in place of the hydroxypropylated starch of Example 1A.

D. The above samples 1A-C were made without steps 7 and 8 to form a liquid creamer.

### Example 2

### Preparation of Non-Dairy Creamer with Higher Level of Stabilized Starch

| Ingredients | Amount (% wt/wt) |
|---|---|
| Palm Oil | 21 |
| 3% OSA treated fluidity (20-40 wf) | 2.7 |
| waxy corn starch | |
| 8% propylene oxide treated fluidity | 0.6 |
| (9-19 wf) tapioca starch | |
| Corn Syrup Solid (42DE) | 35.7 |
| Water | 40 |
| Total | 100 |

Procedure: The procedure of Example 1A was used.

B. The above example was repeated with the exception that a 5% acetylated fluidity (9-19 wf) tapioca starch was used in place of the propylene oxide treated starch of Example 2A.

C. The above example was repeated with the exception that a chlorinated (5.5% chlorine as sodium hypochlorite) fluidity (9-19 wf) tapioca starch was used in place of the hydroxypropylated starch of Example 2A.

D. The above samples 2A-C were made without steps 7 and 8 to form a liquid creamer.

### Example 3

### Preparation of a Control Non-Dairy Creamer without a Stabilized Starch

The non-dairy creamer of Example 1A was prepared without the propylene oxide starch.

| A. Ingredients | Amount (% wt/wt) |
|---|---|
| Palm Oil | 21 |
| 3% OSA treated fluidity (20-40 wf) waxy starch | 2.7 |
| Corn Syrup Solid (42DE) | 36.3 |
| Water | 40 |
| Total | 100 |

Procedure: The procedure of Example 1A was used.

B. The above sample was made without steps 7 and 8 to form a liquid creamer.

### Example 4

### Comparison of Non-Dairy Creamers with and without a Stabilized Starch

Procedure:

8.5 g sugar, 1.8 g instant coffee and 6.0 g coffee creamer were dry-blended.

175 g water was heated to 75 C and the dry-blended powder was added while mixing.

The samples were tasted by a panel of eight people and the results are summarized in Table 1, below.

TABLE 1

| | Bitterness | Acceptability |
|---|---|---|
| Sample | Masking | (# people/total) |
| Sample 3A | Poor | 1/8 |
| (control) | | |
| Sample 1A | Good | 7/8 |
| Sample 1C | Good | 7/8 |
| Sample 1D | Good | 7/8 |
| Sample 2A | Very good | 8/8 |
| Sample 2C | Very good | 8/8 |
| Sample 2D | Very good | 8/8 |

### Example 5

### Preparation of Shortening with Stabilized Starch

| A. Ingredients | Amount (% wt/wt) |
|---|---|
| Palm Oil | 45 |
| 3% OSA treated fluidity (20-40 wf) | 4.0 |
| waxy corn starch | |
| 8% propylene oxide treated fluidity | 0.5 |
| (9-19 wf) tapioca starch | |
| Corn Syrup Solid (42DE) | 10.5 |
| Water | 40 |
| Total | 100 |

Procedure:

1. The solid fat was liquefied by heating in a boiling water bath and was maintained at a temperature of 140-150° F. (˜60-65° C.) once liquefied.

2. Water was heated 140-150° F. (˜60-65° C.) and the starch was added under moderate agitation until completely dispersed.

3. To the above starch solution, the corn syrup solids were added under moderate agitation until the ingredients were thoroughly mixed.

4. While maintaining the starch/corn syrup solids solution at 140-150° F. (˜60-65° C.), the oil was added to the solution using Arde Barinco Benchtop Homogenizer while mixing at 30 setting for two minutes.

5. The above pre-emulsion was homogenized in two passes at 3000/500 psi (20,684,271/3,447,378.5 Pa).

6. The particle size of the emulsion was checked. Mean particle size should be less than 1.5 microns. If necessary to obtain the desired particle size distribution, the emulsion was homogenized one more pass.

7. The sample was spray dried using an outlet temperature between 110-120° C. Throughout the process, the emulsion temperature was maintained at around 140-150° F. (˜60-65° C.).

B. The above example was repeated with the exception that a 5% acetylated fluidity (9-19 wf) tapioca starch was used in place of the propylene oxide treated starch of Example 5A.

C. The above example was repeated with the exception that a chlorinated (5.5% chlorine as sodium hypochlorite) fluidity (9-19 wf) tapioca starch was used in place of the hydroxypropylated starch of Example 5A.

### Example 6

### Preparation of Shortening with Higher Level of Stabilized Starch

| Ingredients | Amount (% wt/wt) |
|---|---|
| Palm Oil | 45 |
| 3% OSA treated fluidity (20-40 wf) | 4.0 |
| waxy corn starch | |
| 8% propylene oxide treated fluidity | 1.0 |
| (9-19 wf) tapioca starch | |
| Corn Syrup Solid s (42DE) | 10 |
| Water | 40 |
| Total | 100 |

Procedure: The procedure of Example 5 was used.

B. The above example was repeated with the exception that a 5% acetylated fluidity (9-19 WF) tapioca starch was used in place of the propylene oxide treated starch of Example 6A.

C. The above example was repeated with the exception that a chlorinated (5.5% chlorine as sodium hypochlorite) fluidity (9-19 wf) tapioca starch was used in place of the hydroxypropylated starch of Example 6A.

### Example 7

### Preparation of a Shortening Sample without Addition of Stabilized Starch

| Ingredients | Wt. Percentage |
|---|---|
| Palm Oil | 45 |
| 3% OSA treated fluidity (20-40 wf) | 4 |
| waxy corn starch | |
| Corn Syrup Solid (42DE) | 11 |
| Water | 40 |
| Total | 100 |

Procedure: The procedure of Example 5 was used.

### A. Example 8

### Comparison of Shortenings Made with and without Addition of a Stabilized Starch

Procedure:

142 g of shortening were placed in the Hobart Mixer bowl.

Vanilla extract (0.4%) was mixed into warm water.

Using the whip attachment and mixing on the lowest speed, 58 g of water containing vanilla were added.

When the mix was well blended, the speed was increased to the highest speed and the mixture was whipped for 2 minutes.

The sides and bottom of the bowl were scraped and whipping was continued on the highest speed for 30 more seconds.

The vanilla frosting/filling was taste tested by a panel of eight and the results are listed in Table 2, below.

TABLE 2

| | Bitterness | Acceptability |
|---|---|---|
| Sample | Masking | (# people/total) |
| Sample 7A | Poor | 1/8 |
| (control) | | |
| Sample 5A | Good | 7/8 |
| Sample 5C | Good | 7/8 |
| Sample 5D | Good | 7/8 |
| Sample 6A | Very good | 8/8 |
| Sample 6C | Very good | 8/8 |
| Sample 6D | Very good | 8/8 |

We claim:

1. A method of improving the flavor in an edible product containing alkenyl succinic starch comprising adding a masking effective amount of a stabilized starch.

2. The method of claim 1, wherein the stabilized starch is selected from the group consisting of a hydroxyalkylated starch, an acetylated starch, a mono-phosphorylated starch, an oxidized starch, an acid hydrolyzed starch and an enzyme hydrolyzed starch.

3. The method of claim 2, wherein the stabilized starch is selected from the group consisting of a hydroxyalkylated starch, an acetylated starch, and a mono-phosphorylated starch.

4. The method of claim 1, wherein the stabilized starch is a hydroxypropylated starch.

5. The method of claim 1, wherein the alkenyl succinic starch is modified using octenyl succinic anhydride.

6. The method of claim 1, wherein the alkenyl succinic starch is modified using dodecenyl succinic anhydride.

7. The method of claim 1, wherein the stabilized starch is a hydroxypropylated starch and the alkenyl succinic starch is modified using octenyl succinic anhydride.

8. The method of claim 1, wherein the stabilized starch is in an amount of at least about 0.05% and no more than about 1.5% by weight of the product.

9. The method of claim 8, wherein the stabilized starch is in an amount of at least about 0.4% and no more than about 0.8% by weight of the product.

10. An edible product containing an alkenyl succinic starch comprising a masking effective amount of a stabilized starch.

11. The product of claim 10, wherein the stabilized starch is selected from the group consisting of a hydroxyalkylated starch, an acetylated starch, a mono-phosphorylated starch, an oxidized starch, an acid hydrolyzed starch and an enzyme hydrolyzed starch.

12. The product of claim 11, wherein the stabilized starch is selected from the group consisting of a hydroxyalkylated starch, an acetylated starch, and a mono-phosphorylated starch.

13. The product of claim 10, wherein the stabilized starch is a hydroxypropylated starch.

14. The product of claim 10, wherein the alkenyl succinic starch is modified using octenyl succinic anhydride.

15. The product of claim 10, wherein the alkenyl succinic starch is modified using dodecenyl succinic anhydride.

16. The product of claim 10, wherein the stabilized starch is a hydroxypropylated starch and the alkenyl succinic starch is modified using octenyl succinic anhydride.

17. The product of claim 10, wherein the stabilized starch is in an amount of at least about 0.05% and no more than about 1.5% by weight of the product.

18. The product of claim 17, wherein the stabilized starch is in an amount of at least about 0.4% and no more than about 0.8% by weight of the product.

19. The edible product of claim 10, wherein the product is selected from the group consisting of a shortening, a coffee whitener and a creamer.

20. The edible product of claim 19, wherein the product is selected form the group consisting of a shortening, a coffee whitener and a creamer.
